(19) United States
(12) Patent Application Publication
(10) Pub. No.: US 2017/0170589 A1
(43) Pub. Date: Jun. 15, 2017

(54) FEMALE TERMINAL FITTING

(71) Applicant: Sumitomo Wiring Systems, Ltd., Yokkaichi (JP)

(72) Inventor: Shinjiro Kida, Yokkaichi (JP)

(21) Appl. No.: 15/350,159

(22) Filed: Nov. 14, 2016

(30) Foreign Application Priority Data
Dec. 11, 2015 (JP) 2015-242059

(51) Int. Cl. H01R 13/11; H01R 13/432; H01R 4/18

(52) U.S. Cl. CPC H01R 13/113; H01R 4/18; H01R 13/432; H01R 2101/00

(57) ABSTRACT

A female terminal fitting (10) includes a main body (12) in the form of a rectangular tube with an open front end, a projection (21) connected to a plate (16) of the main body (12) and projecting with respect to an outer surface (12S) of the main body (12). The projection (21) includes a facing plate (26) arranged to face the outer surface (12S) of the main body (12), and a reinforcing plate (29) extending from a rear end edge of the facing plate (26) toward the outer surface (12S) of the main body (12).

### BACKGROUND

1. Field of the Invention

The invention relates to a female terminal fitting.

2. Description of the Related Art

Japanese Unexamined Patent Publication No. 2005-005110 discloses a female terminal fitting formed by applying bending and the like to a metal plate material. This female terminal fitting includes a main body in the form of a rectangular tube, and a stabilizer in the form of a projection is formed on the outer periphery of the main body. The stabilizer exhibits an erroneous insertion preventing function of preventing the female terminal fitting from being inserted in an improper orientation into a housing.

A conventional stabilizer is formed by striking a part of a plate of the main body. Thus, if an attempt is made to enhance the erroneous insertion preventing function of the stabilizer by increasing a height and/or a width of the stabilizer, the plate that defines the stabilizer becomes relatively thinner, and the strength of the stabilizer may be reduced.

The invention was completed based on the above situation and aims to enhance the strength of a projecting portion projecting from an outer surface of a rectangular tubular main body.

### SUMMARY

The invention is directed to a female terminal fitting with a main body in the form of a rectangular tube with an open front end. A projection is connected to a plate of the main body and projects with respect to an outer surface of the main body. The projection has a facing plate that faces the outer surface of the main body. A reinforcing plate extends from a rear end edge of the facing plate toward the outer surface of the main body.

An external force may act on the projection to bring the facing plate toward the outer surface of the main body. However, the reinforcing plate contacts the outer surface of the main body, thereby preventing deformation of the projection.

An extending end part of the reinforcing plate may be in contact with the outer surface of the main body for reliably preventing deformation of the projection.

The outer surface of the main body may be formed with a recess, and the extending end part of the reinforcing plate may be locked to a rear end edge of the recess from the front. Thus, deformation of the projection can be prevented more reliably.

The projection of the female terminal fitting may include a base plate. The base plate may extend from an outer plate main body substantially at a right angle to the outer surface of the main body and may be connected to a base end part of the facing plate. A support plate of the projection may extend from an extending end part of the facing plate toward the outer surface of the main body, and the extending end part of the reinforcing plate may be locked to a side edge of the recess on the side of the base plate. According to this configuration, even if a lateral external force acts to bring the support plate closer to the base plate, lateral deformation of the projection can be prevented since the extending end part of the reinforcing plate is locked to the side edge part of the recess.

The extending end part of the reinforcing plate may have a cut for accommodating the side edge part of the recess. According to this configuration, the reinforcing plate can be widened toward the base plate by an overlapping dimension of the side edge part of the recess and the cut. Thus, reinforcement performance of the reinforcing plate is improved.

### BRIEF DESCRIPTION OF THE DRAWINGS

FIG. 1 is a perspective view of a female terminal fitting of one embodiment.

FIG. 2 is a rear view of the female terminal fitting.

FIG. 3 is a rear view showing a state where the female terminal fitting is vertically inverted.

FIG. 4 is a front view of the female terminal fitting.

FIG. 5 is a partial enlarged plan view of the female terminal fitting.

FIG. 6 is a section along X-X of FIG. 5.

FIG. 7 is a section along Y-Y of FIG. 5.

FIG. 8 is a development of the female terminal fitting.

FIG. 9 is a section showing a state where the female terminal fitting is inserted in a housing.

### DETAILED DESCRIPTION

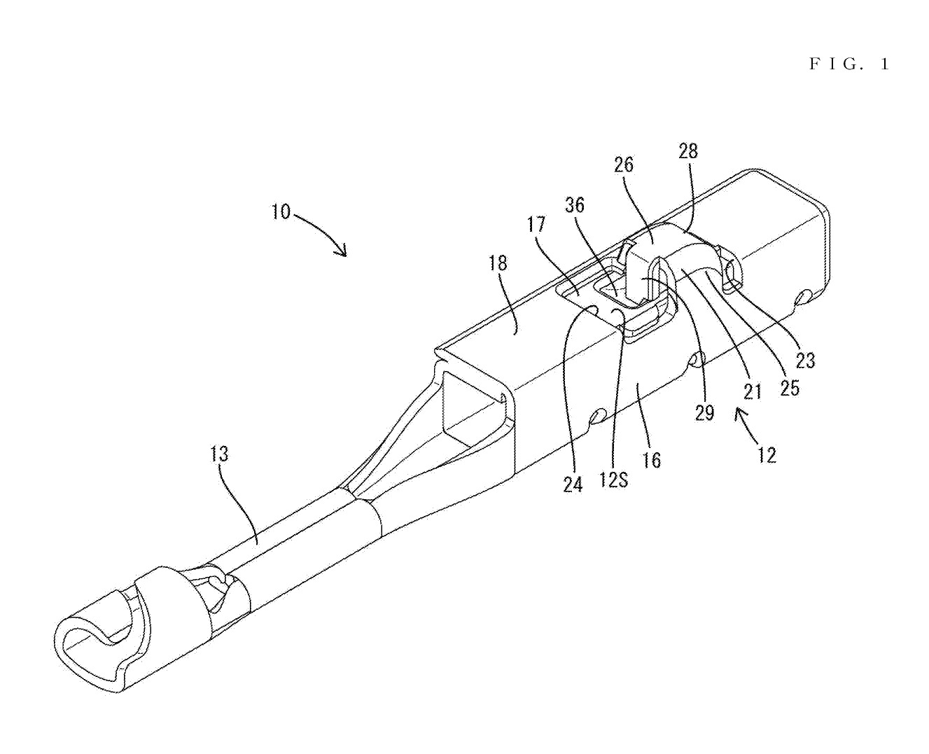

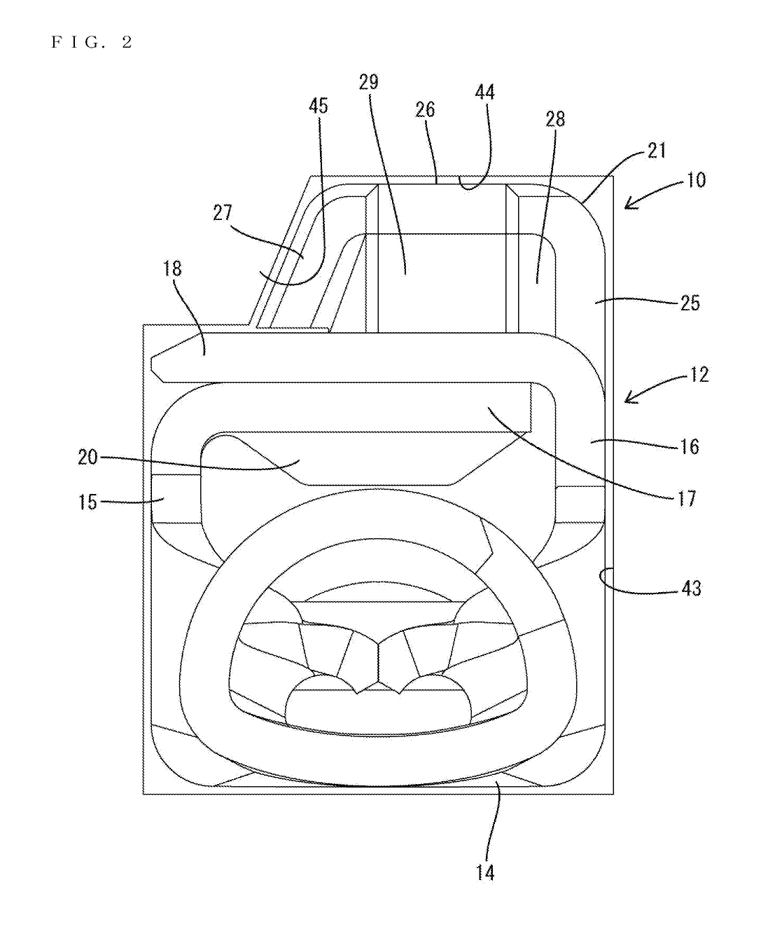

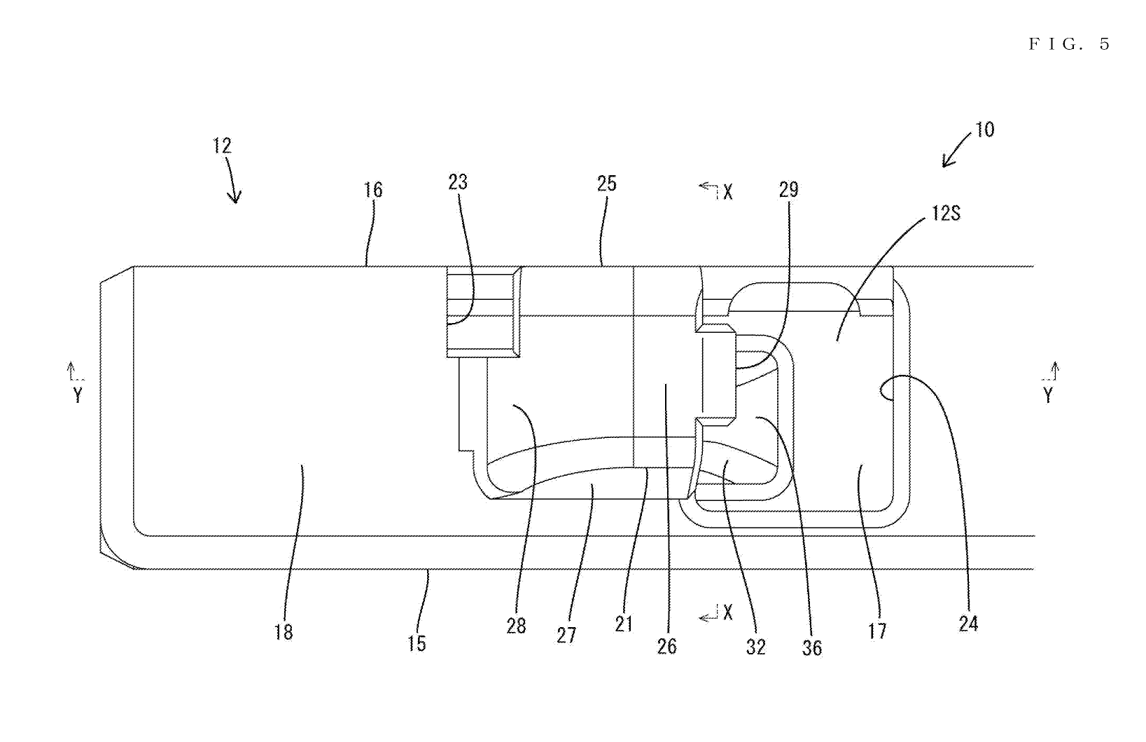

An embodiment of the invention is described with reference to FIGS. 1 to 9. In the following description, a left side in FIGS. 5, 7 and 9 is defined as a front concerning a front-back direction. Further, directions shown in FIGS. 2, 3 and 6 are defined as they are as leftward and rightward directions concerning a lateral direction.

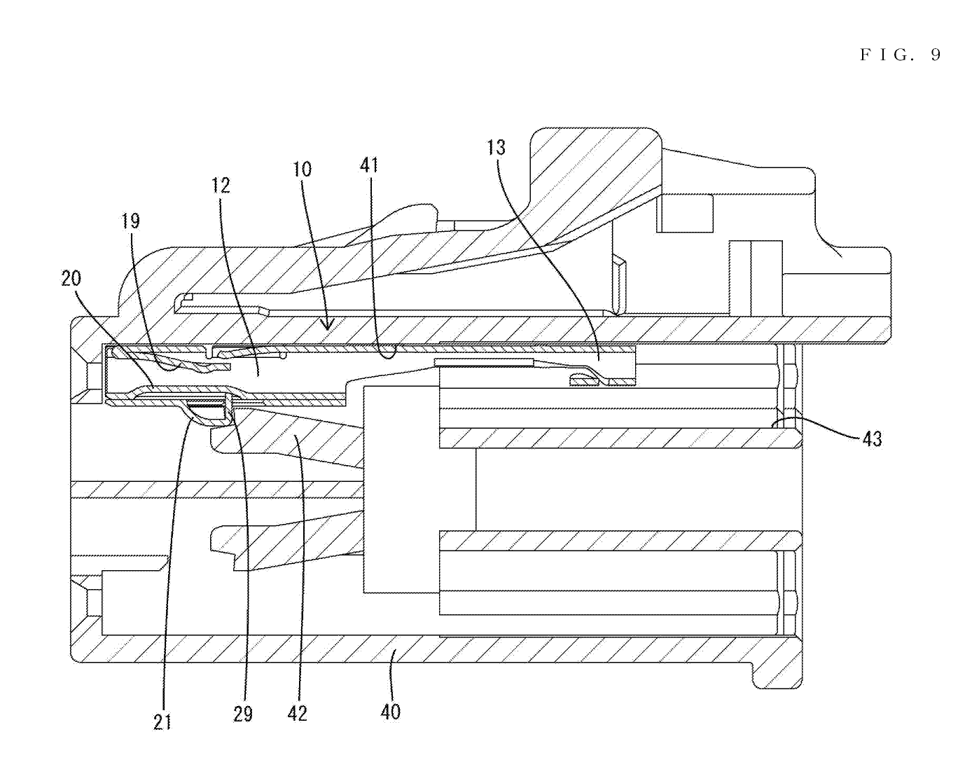

A female terminal fitting 10 of this embodiment is inserted from behind into a terminal accommodating chamber 41 formed in a housing 40, as shown in FIG. 9. A resiliently deformable locking lance is formed in the terminal accommodating chamber 41 and retains the female terminal fitting 10 inserted into the terminal accommodating chamber 41. The locking lance 42 interferes with a projection 21 of the female terminal fitting 10 in the process of inserting the female terminal fitting 10 (incompletely inserted state) and is deflected resiliently. When the female terminal fitting 10 is inserted properly, the locking lance 42 resiliently returns to lock the projecting portion 21 and the female terminal fitting 10 is retained by this locking action.

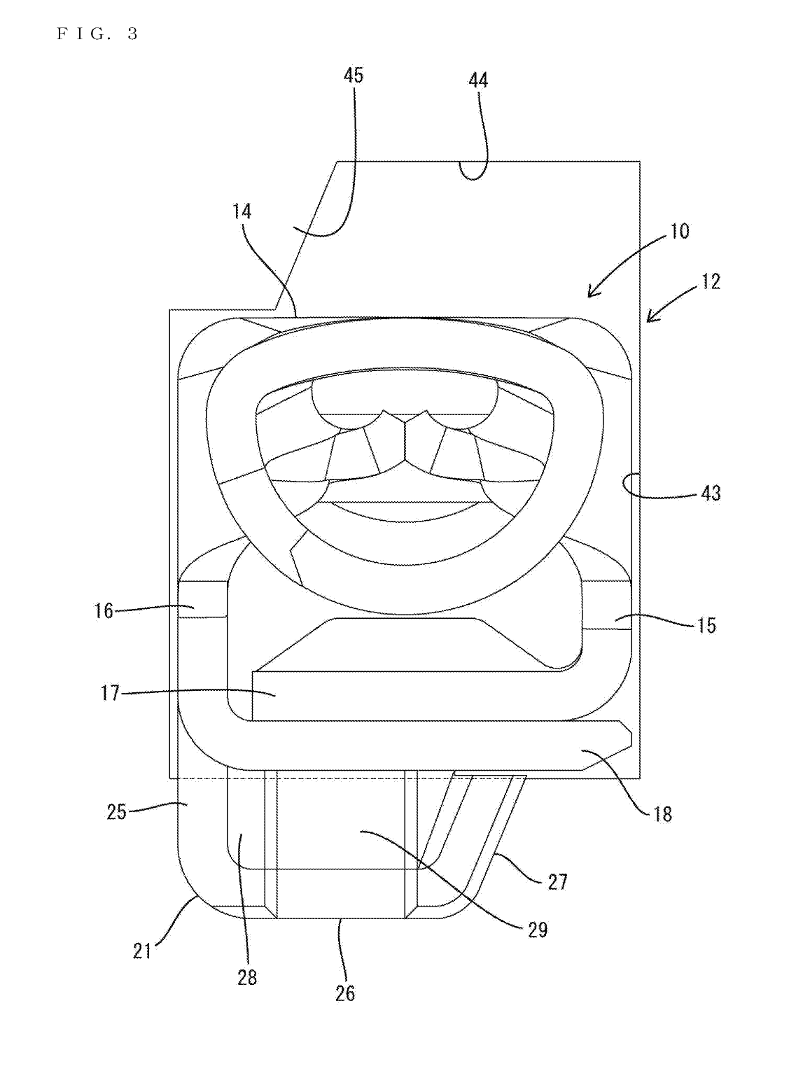

A rear end part of the terminal accommodating chamber 41 is open as a terminal insertion opening 43 on the rear surface of the housing 40. The female terminal fitting 10 is inserted into the terminal accommodating chamber 41 through the terminal insertion opening 43. As shown in FIGS. 2 and 3, the terminal insertion opening 43 has a substantially vertically long rectangular opening shape. Specifically, a width of the terminal insertion opening 43 is constant in a range from the lower end to an area slightly above a center in a height direction, whereas the width is slightly shorter in an upper end part. Further, the upper end part of the opening area of the terminal insertion opening 43 serves as an escaping portion 44 into which the projection 21 to be described later is allowed to enter. The escaping portion 44 is arranged to be shifted to the right when the housing 40 is viewed from behind. By this arrangement, an area of an opening edge part of the terminal insertion opening 43 to the left of the escaping portion 44 defines an interfering portion 45 projecting inward of the terminal insertion opening 43.

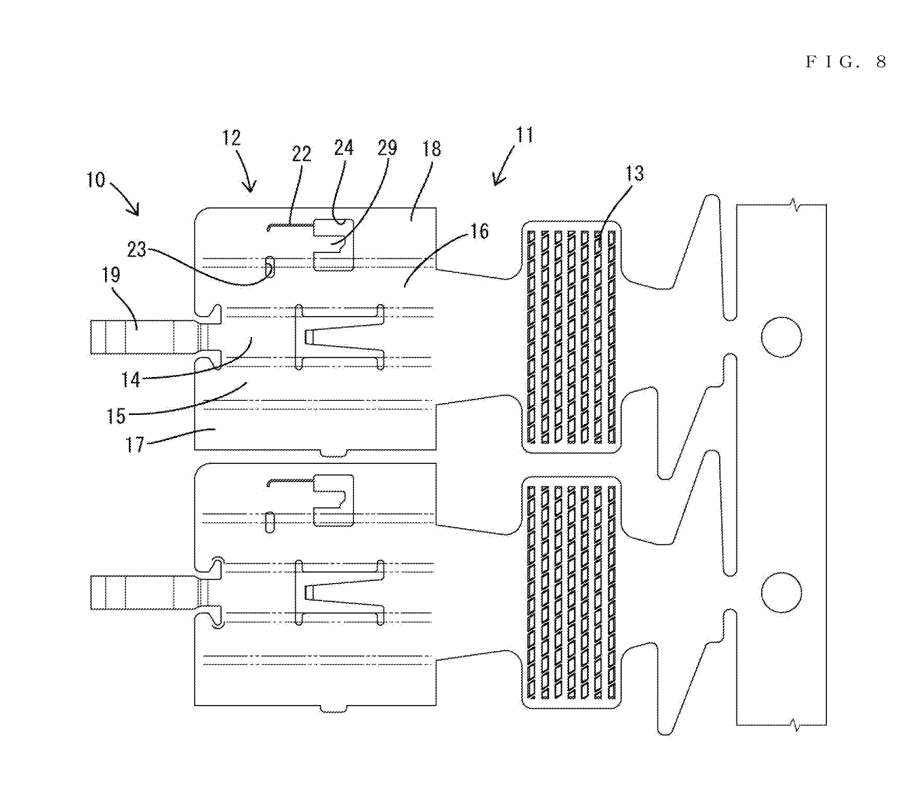

As shown in FIG. 8, the female terminal fitting 10 is formed into a predetermined shape by applying bending and striking to a metal plate material 11 punched out into a predetermined shape. The female terminal fitting 10 is long and narrow in the front-back direction. A rectangular tubular main body 12 is at the front end of the female terminal fitting 10 and has an open front end. A crimping portion 13 is at a rear end part of the female terminal fitting 10 and defines an open barrel. A coated wire (not shown) is crimped and fixed conductively to the crimping portion 13.

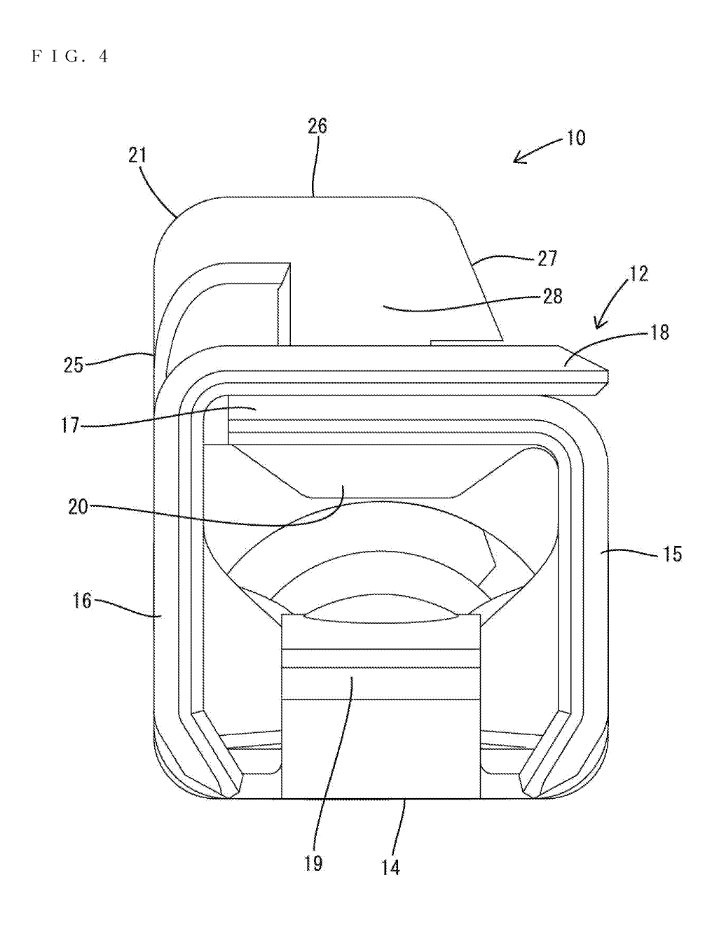

The main body 12 includes a lower plate 14, a left plate 15 standing up from the left side of the lower plate 14, a right plate 16 standing up from the right side of the lower plate 14, an upper plate 17 extending rightward from the upper end of the left plate 15 to face the lower plate 14 and a ceiling plate 18 extending from the upper end of the right plate 16 to face the upper surface of the upper plate 17. As shown in FIG. 4, a resilient contact piece 19 is accommodated in the main body 12 and is folded from the front end of the lower plate 14. The upper plate 17 is formed with a pressure receiving portion 20 struck to project down (inwardly of the main body 12) without almost changing a plate thickness thereof. The lower surface of the pressure receiving portion 20 is facing the upper surface of the resilient contact piece 19.

A tab of a male terminal fitting (not shown) is inserted into the main body 12 from the front. The tab inserted into the main body 12 has the lower surface thereof pressed up by the resilient contact piece 19, thereby being pressed into surface contact with the lower surface of the pressure receiving portion 20. Thus, the tab is sandwiched resiliently between the resilient contact piece 19 and the pressure receiving portion 20. In this way, the female terminal fitting 10 and the male terminal fitting are connected conductively.

The main body 12 is formed with the projection 21 for preventing insertion in an improper orientation such as vertical inversion (see FIG. 3) into the terminal accommodating chamber 41. This projection 21 is a multifunctional part having an erroneous insertion preventing function of the female terminal fitting 10 and a retaining function of retaining the female terminal fitting 10 by being locked to the locking lance 42, as described above. The projection 21 is formed by striking a part of the ceiling plate 18. To perform this striking with high accuracy so that burrs and the like are not formed on the projection 21 after processing, the ceiling plate 18 is formed with a slit 22, an opening 23 and a window hole 24 as shown in FIG. 8.

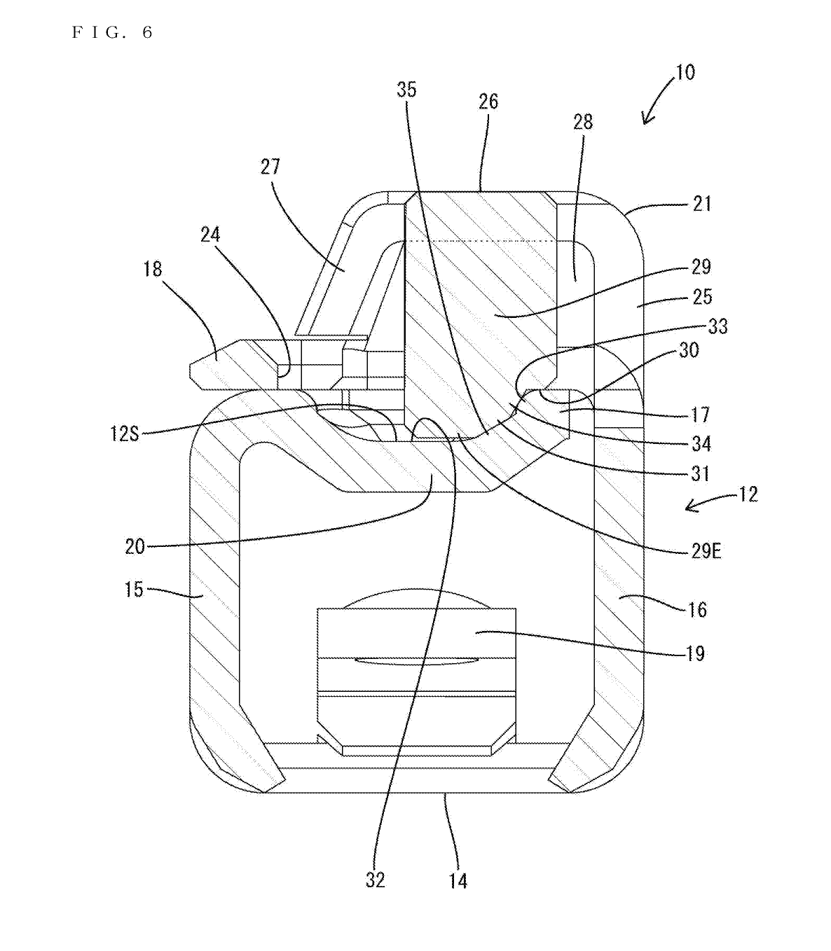

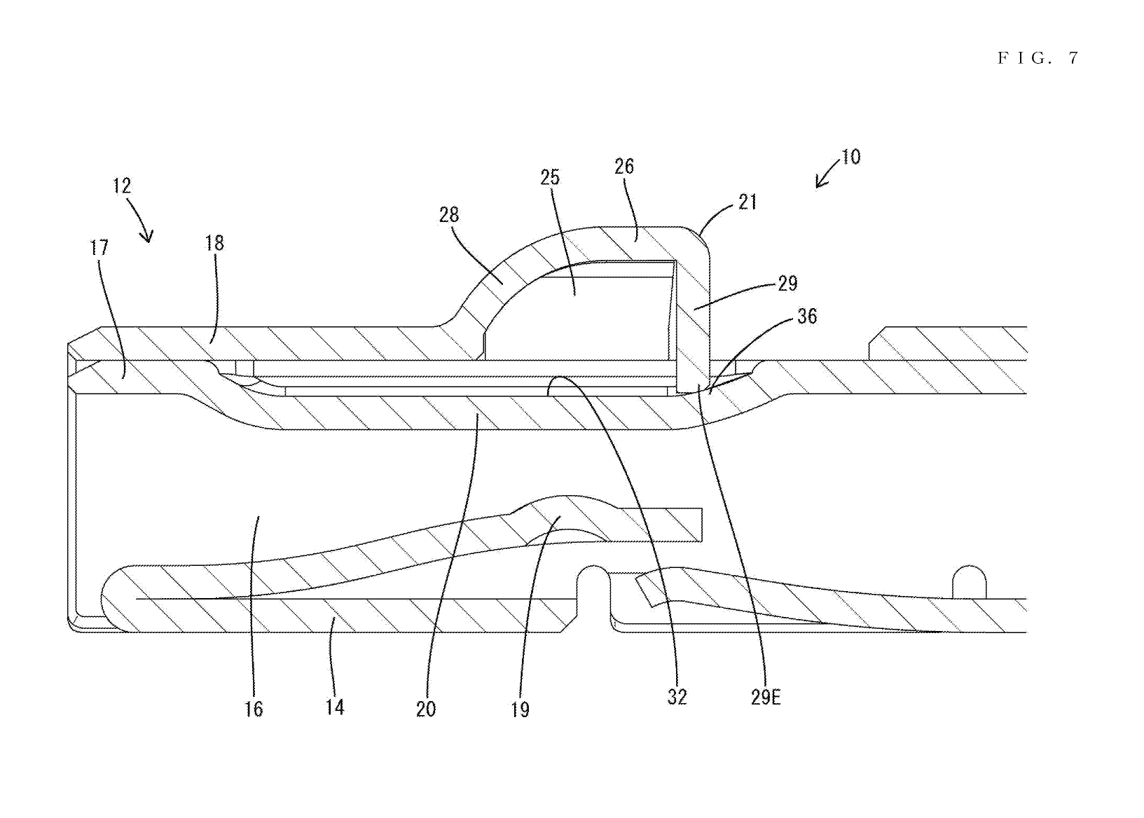

As shown in FIGS. 6 and 7, the projection 21 includes a base plate 25 projecting up from the upper end of the right plate 16 while being flush with the right plate 16, a facing plate 26 extending left at a substantially right angle from the upper end of the base plate 25, a support plate 27 extending obliquely down at an obtuse angle from the left side edge of the facing plate 26, a front plate 28 and a reinforcing plate 29. Any of the base plate 25, the facing plate 26 and the support plate 27 is in the form of a flat plate. The front plate 28 is curved to bulge obliquely to an upper-front in a side view shape from the left or right side. The front plate 28 is connected to the front end edge of the facing plate 26, the front end edge of the support plate 27 and the ceiling plate 18.

A formation area of the facing plate 26 in the lateral direction is a range from the right end of the main body 12 to a position to the right of the left end of the main body 12 (positon substantially in a lateral center). A lower end part of the support plate 27 is arranged at a position slightly to the right of the left end of the main body 12 (position slightly to the left of the lateral center). That is, a formation range of the projection 21 in the lateral direction is an area shifted toward a side to the right of the lateral center out of the entire width of the main body 12 and including the lateral center of the main body 12.

The reinforcing plate 29 is cantilevered down from the rear end edge of the facing plate 26. The reinforcing plate 29 is substantially at a right angle to an outer surface of the ceiling plate 18 in an area where the projection 21 is not formed. Both left and right side edges of the reinforcing plate 29 are not connected to the other plates 25 to 28 of the projection 21. A formation area of the reinforcing plate 29 in the lateral direction is a range from a position slightly to the left of (closer to the center than) the right end of the facing plate 26 to a position substantially in the lateral center of the main body 12 (position slightly to the right of the left end of the facing plate 26). As shown in FIG. 6, a right end part of an extending end part 29E (lower end part) of the reinforcing plate 29 is cut to form a cut 30. Further, an area of the extending end part 29E of the reinforcing plate 29 to the left of and adjacent to the cut portion 30 defines an inclined contact portion 31 having a front shape oblique to the facing plate 26.

The slit 22 formed in consideration of the striking of the projection 21 is arranged in the front-back direction to extend along the lower extending end edge of the support plate 27. Further, the opening 23 is arranged at a position facing a lower end part of the front end of the base plate 25 and a right end part of the front end of the front plate 28. The window 24 is arranged behind and adjacent to the projection 21 in a plan view. An opening area of the window hole 24 in the lateral direction is substantially the same range as the formation area of the projection 21.

Further, an area of the upper surface of the upper plate 17 exposed to the outside through the window 24 is defined as an outer surface 12S of the main body 12. An area of the upper surface of the upper plate 17 including the outer surface 12S of the main body 12 where the pressure receiving portion 20 is formed defines a recess 32. A formation area of the window 24 in the lateral direction is a range including the entire width of the recess 32. Further, an opening area of the window 24 in the front-back direction is a range corresponding to a rear end part of the recess 32 and an area of the outer surface 12S of the main body 12 slightly behind the recess 32. In this way, the rear part of the recess 32 is exposed over the entire width in the window 24. Further, a rear end part of the slit 22 communicates with a left end part of the front end edge of the opening area of the window 24.

As shown in FIG. 6, a central part of the recess 32 in the lateral direction is a plat surface parallel to the lower plate 14 and substantially at a right angle to the reinforcing plate 29. Further, a lock 33 facing leftward (direction opposite to the base plate 25) is formed on a right edge part of the recess 32. The extending end part 29E of the reinforcing plate 29 is accommodated in the window hole 24 and the recess 32. A right edge part of the recess 32 is accommodated in the cut portion 30 of the reinforcing plate 29. A pressure receiving portion 34 of the cut portion 30 facing rightward (toward the base plate 25) is in contact with or proximately facing the locking portion 33.

An inclined receiving portion 35 is defined in an area of the recess 32 adjacent to the lock 33 in the lateral direction. The inclined contact portion 31 of the reinforcing plate 29 is in line or surface contact with the inclined receiving portion 35 from above. The right edge of the reinforcing plate 29 is to the right of the right edge part (locking portion 33) of the recess 32. Further, as shown in FIGS. 5 and 7, an inclined restriction 36 is formed on the rear part of the recess 32 and is inclined down toward the front. The extending end part 29E of the plate-like reinforcing portion 29 is in contact with the inclined restricting portion 36. The left edge of the reinforcing plate 29 is located substantially in a lateral center of the recess 32.

When the female terminal fitting 10 is inserted in a proper orientation into the terminal insertion opening 43, the projection 21 is accommodated into the escaping portion 44 as shown in FIG. 2. Thus the female terminal fitting 10 is accommodated into the terminal accommodating portion 41 without problem. As shown in FIG. 9, the properly inserted female terminal fitting 10 is retained by the plate-like reinforcing portion 29 of the projection 21 being locked by the locking lance 42.

Further, if an attempt is made to insert the female terminal fitting 10 in a vertically inverted improper orientation into the terminal insertion opening 43, as shown in FIG. 3, the projection 21 butts against the opening edge part of the terminal insertion opening 43. Thus, the female terminal fitting 10 cannot be inserted into the terminal accommodating portion 41. Further, if the female terminal fitting 10 is oriented to be slightly inclined in a counterclockwise direction with respect to the proper orientation, the projection 21 butts against the interfering portion 45. Thus, the female terminal fitting 10 cannot be inserted into the terminal accommodating portion 41. Further, if the female terminal fitting 10 is at a right angle to the proper orientation, the projection 21 butts against the opening edge part of the terminal insertion opening 43. Thus, the female terminal fitting 10 cannot be inserted into the terminal accommodating portion 41. As just described, the projection 21 has the erroneous insertion preventing function of the female terminal fitting 10.

Further, the projection 21 is formed by striking the part of the ceiling plate 18 constituting the main body 12. Thus, if an attempt is made to enhance the erroneous insertion preventing function of the female terminal fitting 10 by increasing a height and/or a width of the projection 21, the plates 25 to 28 of the projection 21 become relatively thinner and the strength of the projecting portion 21 may be reduced. As a countermeasure against that, the projection 21 is formed with the plate-like reinforcing portion 29 in the female terminal fitting 10 of this embodiment.

Accordingly, even if a pressing force acts on the front plate 28 of the projection 21 from the front, the reinforcing plate 29 struts since the extending end part 29E of the reinforcing plate 29 is in contact with the inclined restriction 36 on the rear end part of the recess 32. Thus, there is no possibility that the projection 21 is deformed to be inclined backward. If a pressing force acts on the facing plate 26 from above, there is no possibility that the projection 21 is deformed to be squeezed down since the inclined contact portion 31 of the reinforcing plate 29 is in contact with the inclined restricting portion 35 of the recess 32. If a pressing force acts on the support plate 27 from the left, there is no possibility that the projection 21 is deformed to be squeezed or inclined rightward since the pressing portion 34 of the reinforcing plate 29 is in contact with the lock 33 of the recess 32. If a pressing force acts on the base plate 25 to the right, there is no possibility that the projection 21 is deformed to be inclined left since the inclined contact portion 31 of the reinforcing plate 29 is in contact with the inclined receiving portion 35.

As described above, the female terminal fitting 10 of this embodiment includes the main body 12 in the form of a rectangular tube with an open front end, the projection 21 connected to the right plate 16 of the main body 12 and projecting with respect to the outer surface 12S of the main body 12, the facing plate 26 of the projection 21 and arranged to face the outer surface 12S of the main body 12 and the reinforcing plate 29 extending from the rear end edge of the facing plate 26 toward the outer surface 12S of the main body 12. According to this configuration, even if an external force acts on the projection 21 to bring the facing plate 26 closer to the outer surface 12S of the main body 12, the reinforcing plate 29 comes into contact with the outer surface 12S of the main body 12, whereby the deformation of the projection 21 is prevented.

The extending end part 29E of the plate-like reinforcing portion 29 is in contact with the outer surface 12S (inclined receiving portion 35) of the main body 12. Thus, the deformation of the projection 21 can be prevented reliably. Further, since the outer surface 12S of the main body 12 is formed with the recess 32 and the extending end part 29E of the reinforcing plate 29 is locked to the rear end edge (inclined restricting portion 36) of the recess 32 from front, backward deformation of the projection 21 can be prevented more reliably.

Further, the projection 21 includes the base plate 25 extending from the right plate 16 substantially at a right angle to the outer surface 12S of the main body 12 and connected to a base end part of the facing plate 26, and the support plate 27 extending from the extending end part of the facing plate 26 toward the outer surface 12S of the main body 12. The extending end part 29E of the reinforcing plate 29 is locked to the locking portion 33 formed on the side edge of the recess 32 on the side of the base plate 25. According to this configuration, even if an external force (pressing force) from the left side acts to bring the support plate 27 toward the base plate 25, rightward deformation of the projection 21 can be prevented since the extending end part 29E of the plate-like reinforcing portion 29 is locked to the lock 33 (side edge part of the recess 32).

Further, the extending end part 29E of the reinforcing plate 29 is formed with the cut 30 for accommodating the side edge part of the recess 32. According to this configuration, the reinforcing plate 29 can be widened toward the base plate 25 (right side) by an overlapping dimension of the right edge part of the recess 32 and the cut 30. Since this enhances the strength of the reinforcing plate 29, reinforcement performance of the reinforcing plate 29 is also enhanced.

The present invention is not limited to the above described and illustrated embodiment. For example, the following embodiments are also included in the technical scope of the present invention.

Although the extending end part of the reinforcing plate is held in contact with the outer surface of the main body in the above embodiment, it may not be in contact with the outer surface of the main body.

Although the extending end part of the reinforcing plate is locked to the rear end edge of the recess in the above embodiment, it may be held in contact with the recess at a position before the rear end.

Although the extending end part of the reinforcing plate is locked to the side edge of the recess in the above embodiment, it may not be locked to the side edge part of the recess.

Although the extending end part of the reinforcing plate is formed with the cut for accommodating the side edge part of the recess in the above embodiment, it may not be formed with the cut.

Although the outer surface of the main body is formed with recess in the above embodiment, it may not be formed with the recess.

Although the projecting portion extends from the outer plate of the main body substantially at a right angle to the outer surface of the main body in the above embodiment, it may extend from a different part of the main body.

### LIST OF REFERENCE SIGNS

10 . . . female terminal fitting
12 . . . main body
12S . . . outer surface of main body
16 . . . right plate
21 . . . projecting portion
25 . . . base plate
26 . . . facing plate
27 . . . support plate
29 . . . reinforcing plate
29E . . . extending end part of reinforcing plate
30 . . . cut portion
32 . . . recess

What is claimed is:

1. A female terminal fitting (10), comprising:
a main body (12) in the form of a rectangular tube with an open front end;
a projection (21) connected to an outer plate (18) of the main body (12) and projecting with respect to an outer surface of the main body (12), the projection (21) having a facing plate (26) facing the outer surface of the main body (12); and
a reinforcing plate (29) extending from a rear end edge of the facing plate (26) toward the outer surface (12S) of the main body (12).

2. The female terminal fitting of claim 1, wherein an extending end part (29E) of the reinforcing plate (29) is in contact with the outer surface (12S) of the main body (12).

3. The female terminal fitting of claim 2, wherein:
the outer surface of the main body (12) is formed with a recess (32); and
the extending end part (29E) of the reinforcing plate (29) is locked to a rear end edge of the recess (32) from the front.

4. The female terminal fitting of claim 2, wherein the projection (21) further comprises:
a base plate (25) extending from the main body (12) and aligned to the outer plate (18) of the main body (12) substantially at a right angle, the base plate (25) bring unitary with the facing plate (26); and
a support plate (27) extending from an extending end part of the facing plate (26) toward the outer surface (12S) of the main body (21).

5. The female terminal fitting of claim 4, wherein the extending end part (29E) of the reinforcing plate (29) is locked to a side edge part of the recess (32) on a side of the recess (32) substantially adjacent the base plate (25).

6. The female terminal fitting of claim 5, wherein the extending end part of the reinforcing plate (29) is formed with a cut for accommodating the side edge part of the recess (32).
